(19) United States
(12) Patent Application Publication
(10) Pub. No.: US 2002/0143681 A1
(43) Pub. Date: Oct. 3, 2002

(54) Method and system for application service pricing on the internet

(76) Inventors: Hsiang Tsun Yen, Taipei (TW); Chien Sen Weng, Taipei (TW)

Correspondence Address: Michael D. Bednarek, SHAWPITTMAN, 1650 Tysons Boulevard, McLean, VA, 22102-4859, US

(21) Appl. No.: 09/906,059

(22) Filed: Jul. 17, 2001

(30) Foreign Application Priority Data
Mar. 28, 2001 (TW) 090107318

(51) Int. Cl. G06F 17/60; G06F 15/16

(52) U.S. Cl. 705/36; 705/35; 709/203

(57) ABSTRACT

A method and a system for application service pricing on the Internet. The system for application service pricing comprises: a first computer, a second computer, and a user computer. The first computer provides an application and corresponding data transfer service via Internet. The second computer receives the application from first computer via Internet. In addition, the second computer provides the content required for the data transferring service to the first computer. The user computer receives data transferring service provided by the first computer with the application downloaded from the second computer and via Internet. When the user computer executes the downloaded application, it sends an launching message to the first computer that includes identity data of the user computer. The first computer records the number of launching times and updates the record in the second computer. Thereupon the receipt of the record update of the launching record, the second computer makes a payment to the first computer via Internet.

### REFERENCE TO RELATED APPLICATIONS

This application claims the benefit of priority under 35 U.S.C. §119(a) of Taiwan Patent Application No. 090107318, filed Mar. 28, 2001.

### BACKGROUND OF THE INVENTION

1. Field of the Invention

This invention relates generally to an application, and more particularly to a method and a system for application service pricing on the Internet.

2. Description of the Related Art

Currently, methods for application service pricing on the Internet are mainly on a one-payment-off basis. In other words, application service provider offers end-users applications for certain prices. End-users pay off the prices and receive authentication for using the applications. One of the sale channels is credit card purchase online, where end-users link to a website via a browser and proceed to an online order paid by credit card. To complete an order, end-users have to fill up required private information, for example a credit card number etc. It follows that the application service provider then verifies information from the end-users with corresponding credit card organization and deliver the order to the end-users' if the information provided is correct. There are also alternative payment methods available for online purchase. For example, end-users make a cash transfer at the post office and transmit the receipt of the transfer to the application service provider. Upon receipt of the receipt, the application service provider then delivers the order to the end-users. Moreover, transaction can also be done via specified courier service, where courier service acts as an agent for the order delivery and payment collection.

Application service provider on the Internet also provides information and advertising services. In which, the pricing method can either be data based or membership based. A data based method refers to pricing based on a hit count of targeted objects, for example a web page, a banner or a link. The hit count is used as pricing criteria to charge advisers. A membership based is widely used by the application service provider. Membership period depends on the contract, for example can be on a monthly or yearly basis. Advertisers are charged by membership periods regardless of the hit count of the advertisement.

### SUMMARY OF THE INVENTION

The objective of the present invention is to provide a method and a system for application service pricing on the Internet. The system comprises: a first computer, a second computer, and a user computer. The first computer provides an application and corresponding data transfer service via Internet. The second computer receives the application from first computer via Internet. In addition, the second computer provides the content required for the data transferring service to the first computer. The user computer receives data transferring service provided by the first computer with the application downloaded from the second computer and via Internet. When the user computer executes the downloaded application, it sends an launching message to the first computer that includes identity data of the user computer. The first computer records the number of launching times and updates the record in the second computer. Thereupon the receipt of the record update of the launching record, the second computer makes a payment to the first computer via Internet.

Based on said same system, the other objective of the present invention is to provide a method for application service pricing comprises: providing an application from the first computer to the second computer, transferring content required for the data transferring service from the second computer to the first computer and providing a data transferring service from the first computer with said required content from the second computer. The user computer downloads the application from the second computer, which is formerly provided by the first computer. The user computer receives the data transferring service from first computer with the downloaded application from the second computer. When the user computer executes the downloaded application, it sends an launching message to the first computer that includes identity data of the user computer. The first computer records the number of launching times and updates the record in the second computer. Thereupon the receipt of the record update of the launching record, the second computer makes a payment to the first computer via Internet.

### BRIEF DESCRIPTION OF DRAWINGS

The following detailed description, given by way of an example and not intended to limit the invention to the embodiments described herein, will best be understood in conjunction with the accompanying drawings, in which:

FIG. 1 is a schematic diagram illustrates a system for application service pricing on the Internet according to the invention;

FIG. 2 is a block diagram illustrating the process steps of the application service pricing system on the Internet according to the first preferred embodiment of the invention;

FIG. 3 is a block diagram illustrating the process steps of the application service pricing system on the Internet according to the first preferred embodiment of the invention;

FIG. 4 is a block diagram illustrating the process steps of the application service pricing system on the Internet according to the first preferred embodiment of the invention;

FIG. 5 is a block diagram illustrating the process steps of the application service pricing system on the Internet according to the first preferred embodiment of the invention; and

FIG. 6 is a schematic diagram illustrates a system for application service pricing on the Internet according to the second preferred embodiment of the invention.

### DETAILED DESCRIPTION OF THE INVENTION

The following detailed description sets forth two exemplary embodiments, in accordance with the present invention, of a method and a system for application service pricing on the Internet. In the first preferred embodiment, users download application from the application service provider. In the second preferred embodiment, users download a stock reporter application from a stockbroker computer.

First Embodiment

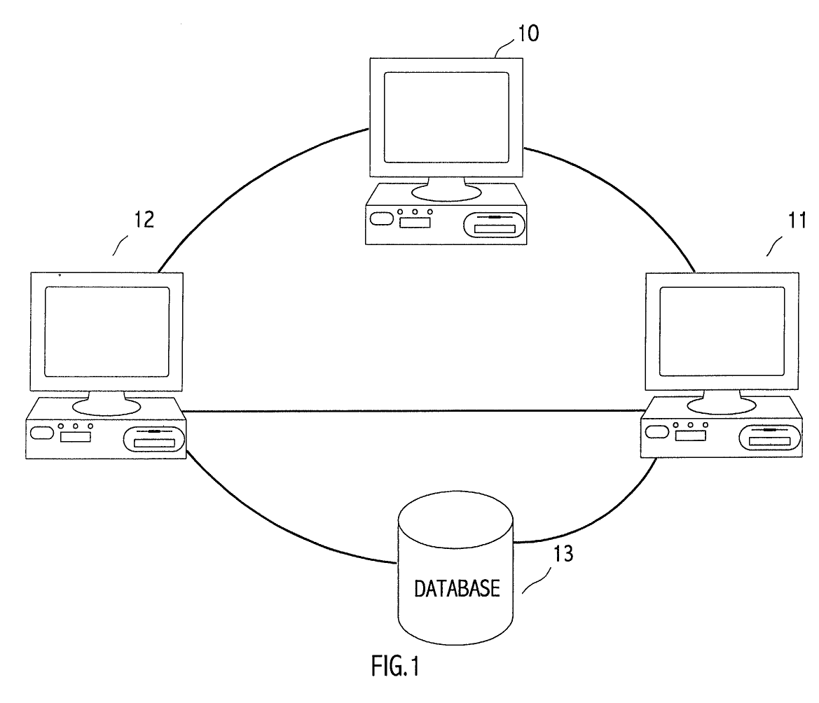

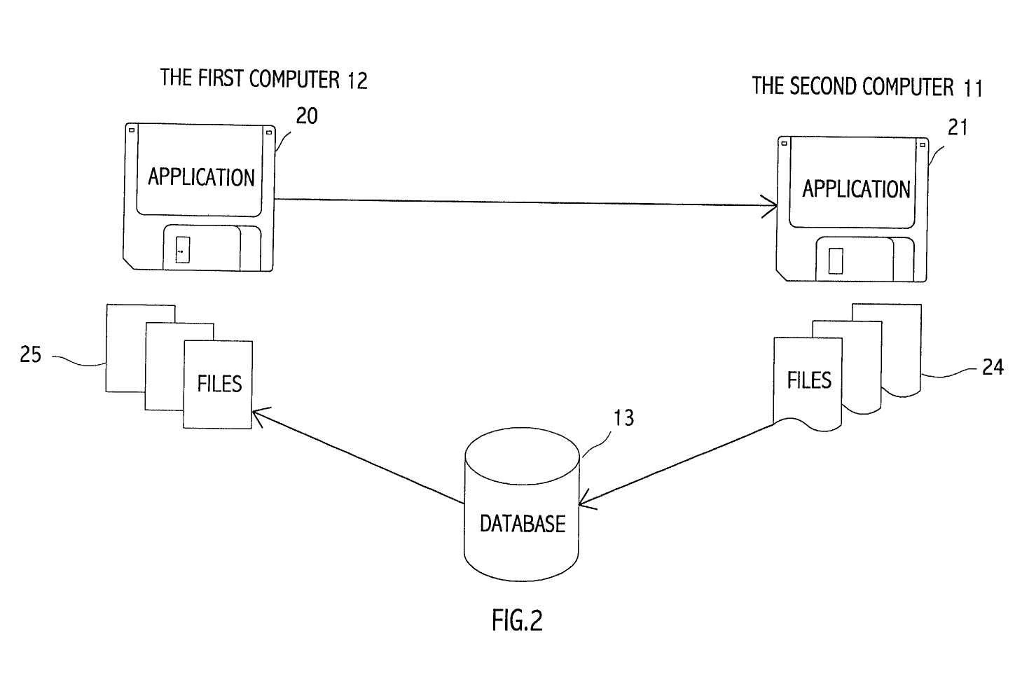

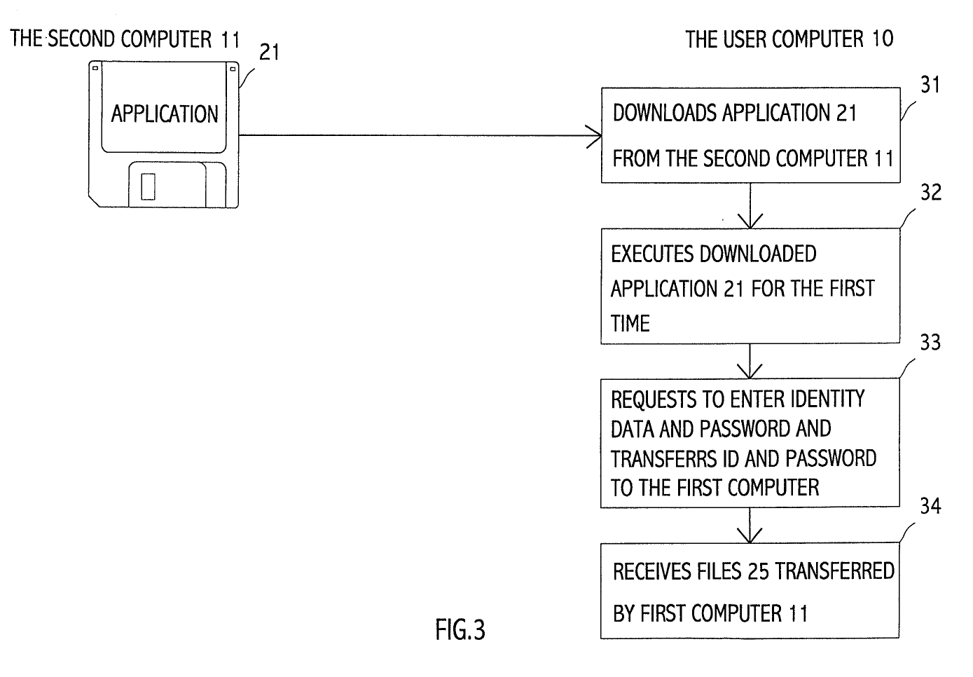

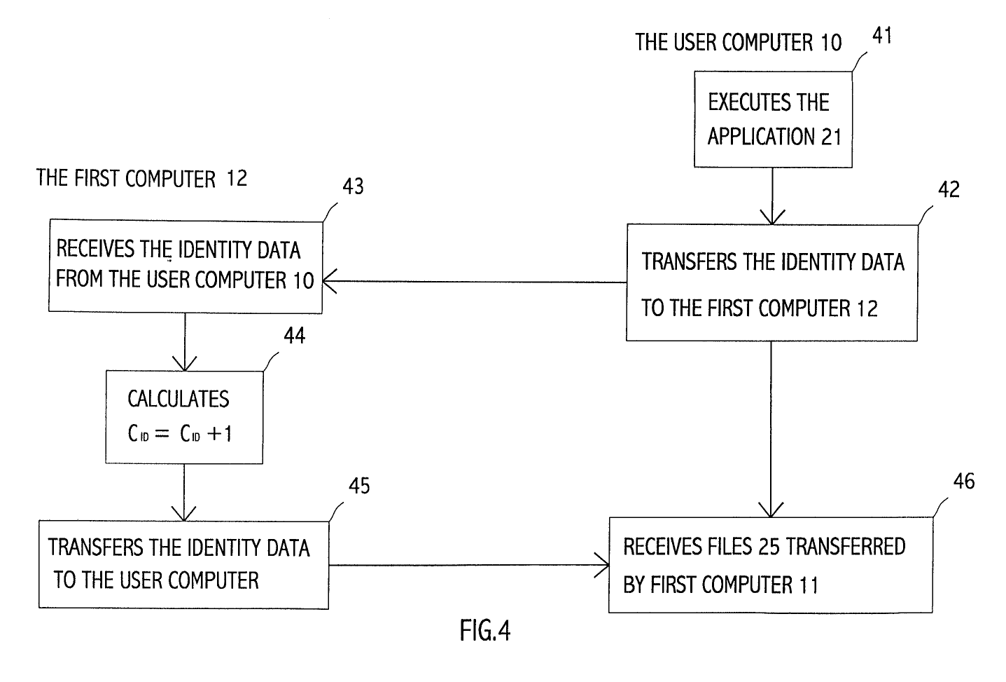

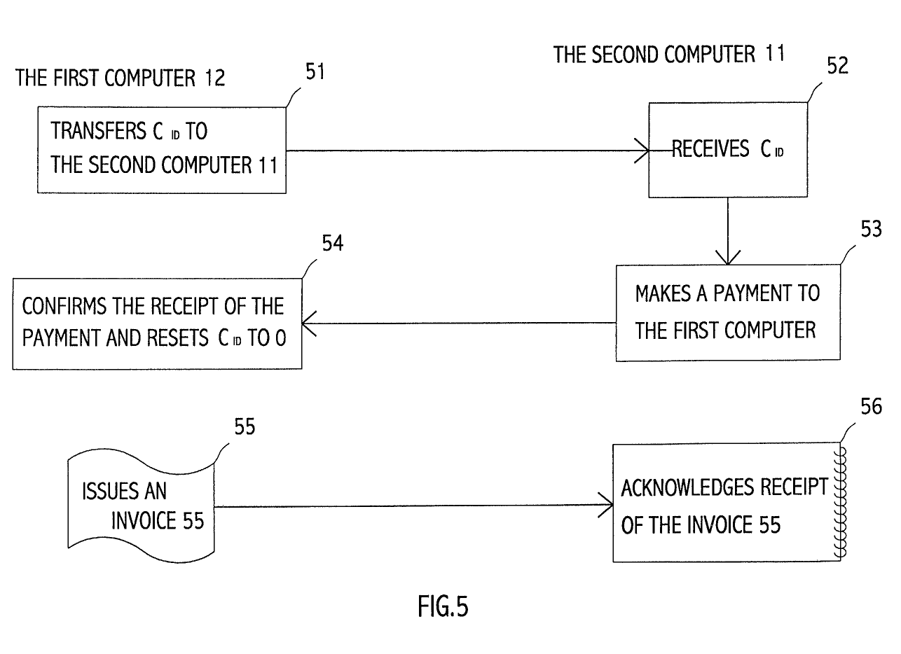

FIG. 1 is a schematic diagram illustrates an embodiment of a system for application service pricing on the Internet according to the invention. FIG. 2, FIG. 3, FIG. 4 and FIG. 5 are detailed process steps in connection with the embodiment shown in the FIG. 1. FIG. 1 illustrates a first computer 12, a second computer 11, a user computer 10 and a database 13. Refers to FIG. 2, the first computer provides an application 20 to the second computer 11. The application 20 is transferred to the second computer and saved as the application 21. The second computer 11 transfers files 24 to the first computer 12 via database 13. The files 24 are transferred to the first computer 12 and saved as files 25.

Refers to FIG. 3, at step 31, the user computer 10 downloads application 21 from the second computer 11. At step 32, user executes downloaded application 21 at user computer 10 for the first time. At step 33, user computer 10 requests the user to enter user's identity data and password. The user computer 10 recorded the ID and the password from the user onto the user computer 10 and identified the information as the identity data required by the application 21. It follows that the identity data are transferred to the first computer 12. After said steps are completed, the first computer 12 receives the identity data, proceeds to computation and transfers files 25 to be execute with the application 21 on the user computer 10. At step 34, the user computer 10 receives files 25 transferred by first computer 11 and accesses to files 25 with application 21.

Refers to FIG. 4, at step 41, the user computer 10 executes the application 21. At step 42, the user computer 10 transfers the identity data from the user computer 10 to the first computer 12. At step 43, the first computer 12 receives the identity data from the user computer 10. At step 44, the first computer 12 calculates the accumulated number of the application launched for the identity data. At step 45, files 25 required by the identity data are transferred to the user computer 10. At step 46, the user computer 10 receives files 25 transferred by first computer 11 and accesses to files 25 with application 21.

Refers to FIG. 4, at the first launching of application 21, the user is required to enter user's ID and password. Thereafter, whenever user computer 10 executes the application 21, identity data of the user computer 10 is transferred to the first computer 12.

While the first computer 12 transfers files 25 to the user computer 10 as shown in FIG. 4, the first computer 12 also calculates the accumulated number of the application launched for the identity data and updates the records to the second computer 11 at step 51 as shown in FIG. 5. At step 52, when the second computer 11 receives the update information of the accumulated number of the application launched of the user computer. At step 53, the second computer 11 makes a payment to the assigned bank account by the first computer based on the accumulated number of the application launched of the user computer either via Internet or joint banking network and sends a payment confirmation notice to first computer 12. At step 54, the first computer 12 resets the accumulated number of the application launched of the user computer 10 to zero; thereupon the first computer 12 receives the payment confirmation notice. At step 55, the first computer 12 issues an invoice 55. At step 56, the second computer 11 sends the invoice 55 to an address assigned and acknowledged receipt by.

Second Embodiment

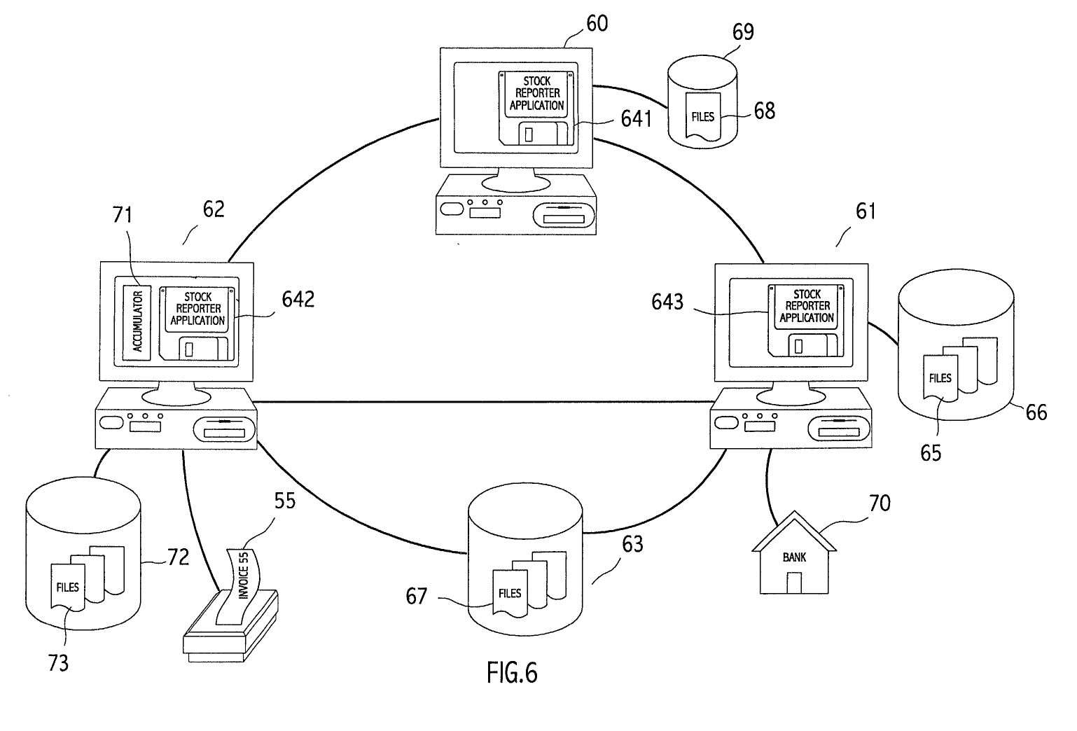

FIG. 6 illustrates a second embodiment of a method and a system for application service pricing on the Internet, where an application service computer 62, a stockbroker computer 61 and a user computer 60 are utilized. Application service provider developed a stock reporter application 642 and saves the stock reporter application 642 on the application service computer 62. The application service computer 62 transfers the stock reporter application 642 to the stockbroker computer 61 and the stock reporter application 642 is saved as stock reporter application 643.

The user computer 60 downloads the stock reporter application 643 via Internet from the stockbroker computer 61 and saves the stock reporter application 643 as the stock reporter application 641. In order to updates the files 66 of the database 65 at the application service computer 62, the files 65 of the database 66 at the stockbroker computer 61 are transferred to database 72 at the application service computer 62 via database 63.

When the user computer 60 firstly executes downloaded stock reporter application 641, the user at user computer 60 is required to enter user's ID and password, wherein the stockbroker computer 61 offers ID and password and the user has to apply for the ID and password in advance. After the user at user computer 60 fills in the ID and password, the information is recorded in the files 68 in the database 69. Moreover, the ID and password then are transferred and saved to the application service computer 62 for verification purpose. After the ID and password are verified, the application service computer 62 retrieves required files 73 in the database 72 and transfers the files 73 to the user computer 60 based onset-up of the stock reporter application 641 at the user computer 60.

Thereafter, whenever the user computer 60 executes the stock reporter application 641, the user computer 60 transfers the ID and password in the files 68 in the database 69 to the application service computer 62. After the application service computer 62 verifies and records the ID and password, the application service computer 62 retrieves required files 73 in the database 72 and transfers the files 73 to the user computer 60 based onset-up of the stock reporter application 641 at the user computer 60.

The application service computer 62 includes an accumulator 71, wherein the accumulated number of the launching of the stock reporter application 641 at the user computer 60 is automatically updated to the stockbroker computer 61. The stockbroker computer 61 makes a payment to the assigned bank account by the application service computer 62 based on the accumulated number of the launching of the stock reporter application 641 at the user computer 60 either via Internet or joint banking network and sends a payment confirmation notice to application service computer 62.

The application service computer 62 resets the accumulated number of the launching of the stock reporter application 641 at the user computer 60; thereupon the application service computer 62 receives the payment confirmation notice. In other words, the application service computer 62 zeros the accumulated number of the launching of the stock reporter application 641 at the user computer 60 and issues an invoice 55. The invoice 55 is mailed to an address assigned by the stockbroker computer 61.

In addition, the application service computer 62 signs a contract with the stockbroker computer 61. The contract contains the charge for each launching of the stock reporter application 641 at a user computer 60. The contract also contains a method regarding the payment for the developing cost of stock reporter application 642 paid by the stockbroker computer 61 to the application service computer 62. The developing cost should be calculated based on the accumulated number of the launching of the stock reporter application 641 at the user computer 60 submitted from the application service computer 62 and the charge for each launching of the stock reporter application 641 at a user computer 60 stipulated in the contract.

While the invention has been described with reference to various illustrative embodiments, the description herein should not be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A system for application service pricing comprises:
a first computer providing an application and corresponding data transfer service via Internet;
a second computer receiving the application from first computer via Internet, the second computer providing the content required for the data transferring service to the first computer; and
a user computer receiving data transferring service provided by the first computer with the application downloaded from the second computer and via Internet;
wherein, when the user computer executes the downloaded application, it sends an launching message to the first computer that includes identity data of the user computer, the first computer records the number of launching times and updates the record in the second computer.

2. The system for application service pricing of claim 1, wherein the second computer makes a payment to the first computer via Internet thereupon the receipt of the record update of the launching record.

3. The system for application service pricing of claim 1, wherein the second computer makes a payment to the first computer via joint banking network thereupon the receipt of the record update of the launching record.

4. The system for application service pricing of claim 1, wherein the launching message includes identity data from the user computer.

5. A method for application service pricing comprises:
providing an application from the first computer to the second computer;
transferring content required for the data transferring service from the second computer to the first computer;
providing a data transferring service from the application service computer with said required content from the stockbroker computer;
downloading the application by the user computer from the second computer, which is formerly provided by the first computer;
receives the data transferring service by the user computer from first computer with the downloaded application from the second computer;
sending an launching message to the first computer that includes identity data of the user computer from the user computer when the user computer executes the downloaded application;
recording the number of launching times and updates the record in the second computer from the first computer;
making a payment from the second computer to the first computer via Internet thereupon the receipt of the record update of the launching record.

6. The method for application service pricing of claim 5, wherein the launching message includes identity data from the user computer.

7. A stock reporter system for application service pricing comprises:
a application service computer providing an application and corresponding data transfer service via Internet;
a stockbroker computer receiving the application from application service computer via Internet, the stockbroker computer providing the content required for the data transferring service to the application service computer; and
a user computer receiving data transferring service provided by the application service computer with the application downloaded from the stockbroker computer and via Internet;
wherein, when the user computer executes the downloaded application, it sends an launching message to the application service computer that includes identity data of the user computer, the application service computer records the number of launching times and updates the record in the stockbroker computer.

8. The stock reporter system for application service pricing of claim 7, wherein the stockbroker computer makes a payment to the first computer via Internet thereupon the receipt of the record update of the launching record.

9. The stock reporter system for application service pricing of claim 7, wherein the stockbroker computer makes a payment to the first computer via joint banking network thereupon the receipt of the record update of the launching record.

10. A stock reporter system for application service pricing of claim 7, wherein the launching message includes identity data from the user computer.

11. A stock reporter method for application service pricing comprises:
providing an application from the application service computer to the stockbroker computer;
transferring content required for the data transferring service from the stockbroker computer to the application service computer;
providing a data transferring service from the application service computer with said required content from the stockbroker computer;
downloading the application by the user computer from the stockbroker computer, which is formerly provided by the application service computer;
receives the data transferring service by the user computer from application service computer with the downloaded application from the stockbroker computer;
sending an launching message to the application service computer that includes identity data of the user computer from the user computer when the user computer executes the downloaded application;
recording the number of launching times and updates the record in the stockbroker computer from the application service computer;
making a payment from the stockbroker computer to the application service computer via Internet thereupon the receipt of the record update of the launching record.

12. The method for application service pricing of claim 11, wherein the launching message includes identity data from the user computer.
